(19) United States
(12) Patent Application Publication
(10) Pub. No.: US 2004/0029089 A1
(43) Pub. Date: Feb. 12, 2004

(54) Weighted cups

(75) Inventors: John L. Goers, Castle Rock, CO (US); Roger Washburn, Centennial, CO (US)

Correspondence Address: SHERIDAN ROSS PC, 1560 BROADWAY, SUITE 1200, DENVER, CO, 80202

(73) Assignee: Speed Stacks, Inc., Englewood, CO (US)

(21) Appl. No.: 10/215,685

(22) Filed: Aug. 9, 2002

(51) Int. Cl. G09B 9/00; G09B 19/00; A63B 69/00

(52) U.S. Cl. 434/250

(57) ABSTRACT

The present invention describes set of weighted practice cups for training for cup stacking competitions as well as the production of the cups and methods of training using the cups.

### FIELD OF THE INVENTION

This application relates generally to a set of practice cups for training for cup stacking competitions and, more specifically, to a set of weighted practice cups as well as the production of the cups and methods of training using the cups.

### BACKGROUND OF THE INVENTION

Cup stacking first became popular in the mid 90s as a method of teaching physical coordination, including hand-to-eye coordination, to youngsters. Cup stacking helps students use both sides of their bodies and brains, develop ambidexterity, develop quickness, and improve concentration. Cup stacking also helps teach sequencing and patterning, which can help in developing math and reading skills. Since the mid 90s, the sport has grown in popularity throughout the country, primarily in elementary schools, where it has become a part of many physical education programs. The sport involves stacking and unstacking a set of specially designed cups in pre-arranged sequences while being timed. The object of the competitions is to complete the sequence or sequences in as short a time as possible. There are several standard sequences and the competitions can be performed by an individual or by a team in a relay fashion.

Participants in other sports, such as hockey, baseball, golf and the like, will warm up and practice with equipment that is weighted heavier than the standard equipment. One common example includes a baseball batter swinging two bats before stepping up to the plate or a baseball batter will use a weighted donut which fits around the bat. In a warm up situation such as the baseball batter with two bats, the batter is momentarily loading the specific muscle groups to a point greater than what will be needed to swing one bat. By doing this, the batter warms up more muscle groups than when swinging at the plate. Because the muscle fibers have a “memory” that extends for several minutes, when standard equipment is used immediately or within a short period of time, a greater number of muscle fibers are employed than the body would normally allocate. This has the effect of making the task “easier” and allowing a more powerful and masterful completion of the task.

In a training situation, the participant who trains with weighted equipment conditions the muscle groups to a greater degree than needed to accomplish the task. In this way, the participant builds strength and power in the muscle groups that will accomplish the task. Again, conditioning the additional muscle groups only makes the task “easier” during competition.

### SUMMARY OF THE INVENTION

The present invention applies the principle of weighting the practice and training equipment to the sport of cup stacking. Participants using the weighted cups of the present invention for a brief period before competition or for training will find that they are able to stack the plurality of competition cups with more ease and speed. The weighted cups of the present invention retain all of the same characteristics including size, dimensions and stacking distance of competition cups, except that the weighted cups are heavier than the competition cups by a factor ranging between 1.1 to 10 times the weight of the competition cups.

The cups used in stacking competitions have a top (instead of a bottom as does a regular cup) and a sidewall. For the ease of the reader, one can also envision a regular cup turned over such that the “base” is now the top. The sidewall of the cup has an edge which is the part of the cup which is placed either on a competition surface or on another cup. Thus, as discussed herein, each cup should be considered to have a top and a sidewall, with the sidewall having an edge.

One embodiment of the invention fixedly secures a weight to the inner surface of the top of the cup. The weight can also be integrated into the top of the cup. Another embodiment of the invention fixedly secures a plurality of weights to the inner surface of the top of the cup. These weights can also be integrated into the top of the cup.

Still another embodiment of the present invention removably secures a weight or a plurality of weights to the inner surface of the top of the cup. The invention also contemplates securing, either fixedly or removably, a weight or a plurality of weights to the inner surface of the sidewall of the cup. The present invention also contemplates a means for weighting the cup including but not limited to making the cup of a denser material to add weight to the cup or adding material, such as additional plastic, polypropylene, or polyethylene, to either the sidewall or the top of the cup.

The present invention also describes a method of training with the weighted cups, which includes using the weighted cups in practice training sessions, and using non-weighted cups during competitions. The method of training also includes attaching weights to the cups, in the embodiments of the cups wherein the weights are removably secured.

The present invention further describes a progressive series of weighted cups, each of which has a progressively different weight. A weight (or plurality of weights) are secured, either removably or fixedly, to the inner surface of the top of these practice cups. Each of the series of cups then has an increasing weight. After the competitor gets accustomed to a first weight, the competitor can graduate to a higher weight to train.

These and other objects, features, and advantages of the invention will become apparent from the following best mode description, the drawings and the claims.

### BRIEF DESCRIPTION OF THE DRAWINGS

The figures which follow depict a preferred embodiment of the invention, and may depict various alternative embodiments. The invention is not limited to the embodiment or embodiments depicted herein since even further various alternative embodiments will be readily apparent to those skilled in the art. For the ease of the reader, like reference numerals in various drawing figures refer to identical structural elements or components.

FIG. 1 depicts a plurality of weighted cups stacked in a 3-6-3 stack.

FIG. 2 depicts an overall view of a weighted cup.

FIG. 3 depicts a cutaway view of the weighted cup of the present invention along the lines AA in FIG. 2.

FIG. 4 depicts a cutaway view of the weighted cup of one embodiment of the present invention.

FIG. 5 depicts a cutaway view of the weighted cup of another embodiment of the present invention.

FIG. 6 depicts a cutaway view of the weighted cup of yet another embodiment of the present invention.

For the ease of the reader in referring to the drawings, the following component list is provided:

| | |
|---|---|
| Weighted Cup | 10 |
| Top | 11 |
| Side | 12 |
| Bottom | 13 |
| Weight | 20 |
| 2^{nd} Weight | 21 |

### DETAILED DESCRIPTION OF THE INVENTION

At the outset, it should be understood that this invention comprises a set of weighted practice cups for training for cup stacking competitions as well as the production of the cups and methods of training using the cups. The description which follows describes a preferred embodiment of the invention, and various alternative embodiments. It should be readily apparent to those skilled in the art, however, that various other alternative embodiments may be accomplished without departing from the spirit or scope of the invention.

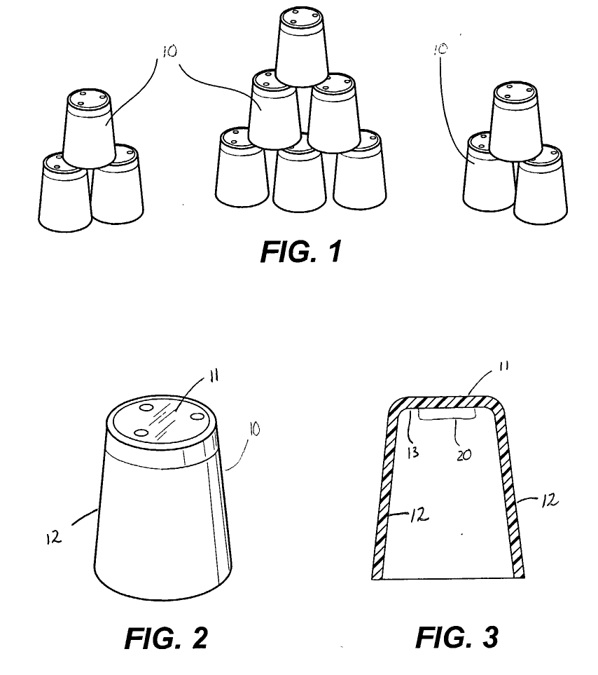

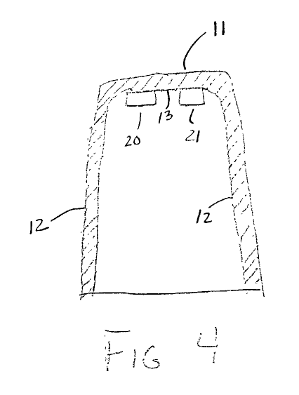

With reference to FIG. 1, a set of weighted cups 10 in a 3-6-3 stacked position are shown. FIG. 2 depicts an individual cup 10 having a top 11 and a sidewall 12. The cup can be made of any material; typically, the cup is made from polypropylene or polyethylene. FIG. 3 depicts a cutaway view of one embodiment of the present invention. The cup 10 has a top 11 with an inner surface 13 and a sidewall 12. A weight 20 is secured to the inner surface 13 of the top 11 of the cup 10.

The weight can be made of any material that will add weight to the cup including but not limited to steel, lead, steel alloys, copper, aluminum, brass, silver, gold, plastic or any combination of the above. The weight can be of any shape or size that will allow the weight to meet the desired weight requirements to be attached to the cup. The weight range of the weights can be from about 2 grams to about 200 grams; preferably, the weight range of the weights can be from about 5 grams to about 100 grams; even more preferably, the weight range of the weights can be from about 25 grams to about 75 grams.

The weight can be fixedly secured to the cup through the use of any means of fixedly securing the weight, including but not limited to glue, double sided tape, epoxy, bonding materials, adhesives, two part adhesives, transfer tapes, rivets, screws, Tinnerman nuts, nuts and bolts, interference fits built into the cup, retaining rings or any combination of the above. The weight 20 can also be removably secured to the cup through the use of any means of removably securing the weight, including but not limited to threaded connections, fasteners, retaining rings, Velcro, snaps, pouches, magnets, clasps, hooks and eyes, clamps, bands, or any combination thereof.

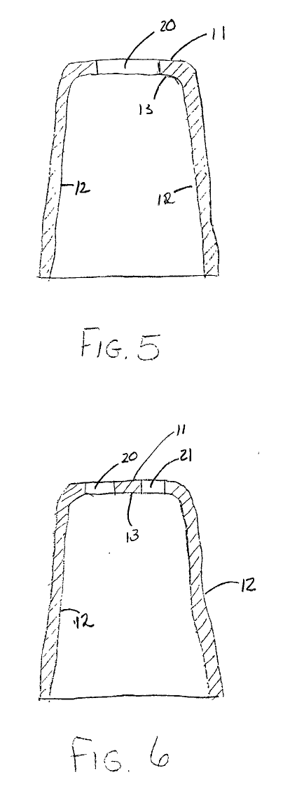

FIG. 4 depicts another embodiment of the present invention wherein a plurality of weights 20 and 21 are secured to the inner surface 13 of the top 11 of the cup 10. FIG. 5 depicts an embodiment of the present invention wherein the weight 20 is built into or is integral with the top 11 of the cup 10. FIG. 6 depicts an embodiment of the present invention wherein a plurality of weights 20 and 21 are built into or integral with the top 11 of the cup 10.

The weighted cup of the present invention, while described as having weights attached to the cup, could also be made from a high density material that weighs more than the material typically used for cups of this sort. Such high density materials include but are not limited to high density plastics, metals, and the like.

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations and changes may be made by those skilled in the art without departing from the spirit of the present invention. Accordingly, the foregoing best mode of carrying out the invention should be considered exemplary in nature and not as limiting to the scope and spirit of the invention as set forth in the appended claims.

We claim:

1. A method of training for cup stacking competitions comprising:
attaching a weight to a cup;
using the weighted cup during practice training sessions; and,
using non-weighted cups during competition.

2. The method of claim 1 wherein the weight which is attached to the cup ranges from about 2 grams to about 200 grams.

3. The method of claim 1 further comprising using a differently weighted cup during practice training sessions.

4. A method of training for cup stacking competitions, comprising:
using a weighted cup during practice training sessions; and,
using non-weighted cups during competitions.

5. The method of claim 4 wherein the weight attached to the cup ranges from about 2 grams to about 200 grams.

6. The method of claim 4 further comprising using a differently weighted cup during practice training sessions.

7. A progressive series of sets of practice cups each of which has a progressively different weight, wherein each practice cup comprises:
a top having an inner surface;
a sidewall attached to the top of the cup and extending downwardly from said top, the sidewall having a lower edge and an inner surface such that the lower edge can be placed on a surface;
at least one weight secured to the inner surface of the top; and,
wherein the at least one weight increases in weight for each cup in the series of practice cups.

8. The progressive series of sets of cups of claim 7 wherein at least one weight is either fixedly or removably secured to the inner surface of the top of the cup.

9. A cup used in practicing for cup stacking competitions, comprising:
a top having an inner surface;
a sidewall attached to the top of the cup and extending downwardly from said top, the sidewall having a lower edge and an inner surface such that the lower edge can be placed on a surface; and,
a weight secured to the inner surface of the top.

10. The cup of claim 9 wherein the weight attached to the cup ranges from about 2 grams to about 200 grams.

11. The cup of claim 9 wherein the weight attached to the cup ranges from about 5 grams to about 100 grams.

12. The cup of claim 9 wherein the weight attached to the cup ranges from about 25 grams to about 75 grams.

13. The cup of claim 9 wherein the weight is either fixedly or removably secured to the inner surface of the top.

14. The cup of claim 13 wherein the weight is fixedly secured to the inner surface of the top through one of the following glue, double sided tape, epoxy, bonding materials, adhesives, two part adhesives, transfer tapes, rivets, screws, Tinnerman nuts, nuts and bolts, interference fits built into the cup, retaining rings or any combination thereof.

15. The cup of claim 13 wherein the weight is removably secured to the inner surface of the top through one of the following threaded connections, fasteners, retaining rings, Velcro, snaps, pouches, magnets, clasps, hooks and eyes, clamps, bands, or any combination thereof.

16. A cup used in practicing for cup stacking competitions, comprising:
a top having an inner surface;
a sidewall attached to the top of the cup and extending downwardly from said top, the sidewall having a lower edge and an inner surface such that the lower edge can be placed on a surface; and
a plurality of weights fixedly secured to the inner surface of the top.

17. The cup of claim 16 wherein the plurality of weights attached to the cup ranges from about 2 grams to about 200 grams.

18. The cup of claim 16 wherein the plurality of weights attached to the cup ranges from about 5 grams to about 100 grams.

19. The cup of claim 16 wherein the plurality of weights attached to the cup ranges from about 25 grams to about 75 grams.

20. The cup of claim 16 wherein the plurality of weights are attached to the inner surface of the cup such that the cup is balanced when placed on a surface.

21. The cup of claim 16 wherein the weight is fixedly secured to the inner surface of the top through one of the following glue, double sided tape, epoxy, bonding materials, adhesives, two part adhesives, transfer tapes, rivets, screws, Tinnerman nuts, nuts and bolts, interference fits built into the cup, retaining rings or any combination thereof.

22. The cup of claim 16 wherein the weight is removably secured to the inner surface of the top through one of the following threaded connections, fasteners, retaining rings, Velcro, snaps, pouches, magnets, clasps, hooks and eyes, clamps, bands, or any combination thereof.

23. A cup used in practicing for cup stacking competitions, comprising:
a top having an inner surface;
a sidewall attached to the top of the cup and extending downwardly from said top, the sidewall having a lower edge and an inner surface such that the lower edge can be placed on a surface; and
a plurality of weights removably secured to the inner surface of the top.

24. The cup of claim 23 wherein the plurality of weights attached to the cup ranges from about 2 grams to about 200 grams.

25. The cup of claim 23 wherein the plurality of weights attached to the cup ranges from about 5 grams to about 100 grams.

26. The cup of claim 23 wherein the plurality of weights attached to the cup ranges from about 25 grams to about 75 grams.

27. The cup of claim 23 wherein the plurality of weights are removably attached to the inner surface of the cup such that the cup is balanced when placed on a surface.

28. The cup of claim 23 wherein the weight is fixedly secured to the inner surface of the top through one of the following glue, double sided tape, epoxy, bonding materials, adhesives, two part adhesives, transfer tapes, rivets, screws, Tinnerman nuts, nuts and bolts, interference fits built into the cup, retaining rings or any combination thereof.

29. The cup of claim 23 wherein the weight is removably secured to the inner surface of the top through one of the following threaded connections, fasteners, retaining rings, Velcro, snaps, pouches, magnets, clasps, hooks and eyes, clamps, bands, or any combination thereof.

30. A cup used in practicing for cup stacking competitions, comprising:
a top and a weight integral with the top; and,
a sidewall attached to the top of the cup and extending downwardly from said cup, the sidewall having a lower edge and an inner surface such that the lower edge can be placed on a surface.

31. The cup of claim 30 wherein the weight attached to the cup ranges from about 2 grams to about 200 grams.

32. The cup of claim 30 wherein the weight attached to the cup ranges from about 5 grams to about 100 grams.

33. The cup of claim 30 wherein the weight attached to the cup ranges from about 25 grams to about 75 grams.

34. A cup used in practicing for cup stacking competitions, comprising:
a top;
a sidewall attached to said top and extending downwardly from the top, the sidewall having a lower edge and an inner surface such that the lower edge can placed on a surface; and,
a plurality of weights secured to the inner surface of the sidewall at various intervals such that the cup is balanced when placed on a surface.

35. The cup of claim 34 wherein the plurality of weights to the cup ranges from about 2 grams to about 200 grams.

36. The cup of claim 34 wherein the plurality of weights attached to the cup ranges from about 5 grams to about 100 grams.

37. The cup of claim 34 wherein the plurality of weights attached to the cup ranges from about 25 grams to about 75 grams.

38. A cup used in practicing for cup stacking competitions, comprising:
a top having an inner surface;
a sidewall attached to the top and extending downwardly from the top, said sidewall having a lower edge and an inner surface such that the lower edge can be placed on a surface; and,
means for weighting the cup secured to the inner surface of either the top or the sidewall of the cup wherein the cup has an initial weight and a final weight and wherein the final weight is greater than the initial weight.

39. The cup of claim 38 wherein the means for weighting the cup increases the final weight of the cup from about 2 grams to about 200 grams.

40. The cup of claim 38 wherein the means for weighting the cup increases the final weight of the cup from about 5 grams to about 100 grams.

41. The cup of claim 38 wherein the means for weighting the cup increases the final weight of the cup from about 25 grams to about 75 grams.

42. The cup of claim 38 wherein the means for weighting the cup are removably attached to the inner surface of the cup such that the cup is balanced when placed on a surface.

43. The cup of claim 38 wherein the means for weighting the cup is fixedly secured to the inner surface of the cup such that the cup is balanced when placed on a surface.

44. The cup of claim 38 wherein the means for weighting the cup includes adding material to the sidewall and the top of the cup.

45. The cup of claim 38 wherein the means for weighting the cup includes using a more dense material in manufacturing the sidewall and the top of the cup.
